(19) United States
(12) Patent Application Publication
(10) Pub. No.: US 2010/0155414 A1
(43) Pub. Date: Jun. 24, 2010

(54) Method for automatic microfluidic fragrance dispensing

(76) Inventor: Zhiyu Hu, Knoxville, TN (US)

Correspondence Address: ROBERT J. LAUF, 998 W. OUTER DRIVE, OAK RIDGE, TN, 37830, US

(21) Appl. No.: 12/660,558

(22) Filed: Mar. 1, 2010

Related U.S. Application Data
(62) Division of application No. 11/312,911, filed on Dec. 20, 2005.

(51) Int. Cl. G01F 11/00

(52) U.S. Cl. 222/1

(57) ABSTRACT

A method and apparatus for dispensing fragrance into the air in the vicinity of the user comprises a liquid reservoir and a solid-state microfluidic controller actuated by a solid-state switching device. The microfluidic device is designed to pump the fragrant material onto the surface of the device, from which the material evaporates, thereby releasing a scent under the manipulation of an electrical circuit, which is preferably battery powered. The entire device consisting of fluid reservoir, pump or valve, power supply, and electronic controls, is preferably small enough to be conveniently attached to clothing or worn by the user. The device may further be contained in a substantially decorative housing and worn like jewelry. The device may be pre-programmed to dispense automatically according to a preset cycle, or it may be adjustable or programmable to some degree by the user.

### CROSS REFERENCE TO RELATED APPLICATION

This application is a Divisional Application of U.S. patent application Ser. No. 11/312,911, filed by the present inventor on Dec. 20, 2005, the entire disclosure of which is incorporated herein by reference.

### BACKGROUND OF THE INVENTION

1. Field of the Invention

The invention pertains to apparatus and methods for dispensing fragrances and more particularly to wearable microfluidic dispensers for releasing controlled amounts of fragrance compounds at controlled intervals.

2. Description of Related Art

Fragrances and perfumes can be applied onto skin, clothes or other objects for releasing scent and odor. There are two basic techniques for perfume application. One is to directly apply perfume/cologne liquid or concentrate onto the targeted subject. Another is to pump through a dispenser that vaporizes the perfume via a fan or atomizes the liquid perfume into many very small mist droplets by compressed air flow. These application methods have been around for centuries. The main disadvantages of these methods include: 1. The scent concentration generally is too strong right after the application then it becomes weaker over the time. The user has no control of scent concentration level over time. 2. Many perfume/cologne are designed in such a way once they are applied onto skin the user's body heat acts like a vaporizer or scent dispenser to promote the circulation of odor. The problem is that same perfume/cologne might react differently on the people's skins, altering the scent and, in some cases, causing irritation or allergic reactions. 3. To change the scent from one perfume to another, one needs to remove the first and apply the new perfume. This might be impractical because of the time constraints or restrictions of social circumstances. 4. Chemicals such as alcohol or aldehyde often are preferred choice of solvent and they are also the odor carrier of perfume as they evaporate. But they could also cause skin irritation and other problems. For example, the odor of these chemicals might interfere with the scent of perfume.

As used herein, the term “fragrance” includes any natural or synthetic volatile compounds, solutions, or mixtures that have some intended olfactory effect in humans or animals. The effect may be conscious, as in the case of perfume or cologne, or subconscious, as in the case of pheromones. The compounds may be relatively undetectable by the user yet have desired masking effects against the olfactory senses of animals. Examples include so-called insect repellents as well as scent masking agents for hunters. A further class of fragrances for which the present invention may be used includes various scented agents to which medicinal effects have been attributed, i.e., so-called “aromatherapy” agents.

Perfume is the term applied to a strong alcoholic solution of odorants, as opposed to weaker solvents such as toilet waters and eaux de cologne. Colognes, eaux de toilette, eaux de parfum, and other “dilute perfumes” have a concentrate content of 3% to 8% prepared in a 75° to 90° alcohol solution. They contain perfume oil, water (the presence of water generally increases the persistence of odors on the skin), and alcohol. Perfumes generally cover a range of 10% to 35% concentrate with an alcoholic strength between 85° and 95°. A higher perfume concentration does not mean higher strength and tenacity; too high a concentration causes the fragrance to be dull and non-diffusing. It has been known for some time that perfumes that had lasting success had similar or identical evaporation behaviors.

Natural odorants in perfumery are generally classified into seven categories: 1. Concrete Oils or ‘natural flower oils’: Flowers, leaves, and roots are subjected to extraction by hydrocarbon solvents, which dissolve the waxes containing the odorous principles from the flowers. The concrete of the flowers has the appearance of solid wax and is insoluble in water and alcohol. It is possible to dissolve it by mixing in 95° alcohol for about a month. Odorous products of the flower are then obtained. 2. Absolute Oils: Obtained by extracting concretes with alcohol, then eliminating the alcohol at reduced pressure. The product obtained is soluble in alcohol and has the consistency of honey. 3. Essential Oils: Derived from a distillation process applied to flowers, leaves, stalks, herbs, roots, and certain fruits. They are the most widely used of all natural perfumery materials. Some oxidation-prone essential oils are treated on production site with traces of antioxidants. 4. Essential Oils Obtained by Expression: Citrus fruits yield essential oil by squeezing the peels. 5. Isolates etc. from Essential Oils: These products are midway between natural and synthetic products. 6. Natural Odorants as Tinctures: Some natural products are used in the form of tinctures by mixing in 95° alcohol for a period of time. Examples include animal musk, ambergris, civet, castoreum, root, and oakmoss. 7. Balsams and Resins: Resin materials found on trees and plants are extracted with different solvents.

Synthetic products used in perfumery include the following: 1. Aldehydes, esters, ethers, ketones, and lactones. 2. Methyl heptin carbonate (MHC), a potent alkyne carbonate used with restraint and discrimination, has a fresh, penetrating odor used as an odorant of green, violet-leaf fragrances, when used in 5% dilution gives excellent, long-lasting effects in violet gardenia, freesia, and other perfumes. 3. Phenylacetaldehyde gives a pungent green odor used as constituent of spring flower perfumes, but is somewhat unstable. 4. Dimethyl acetal gives a characteristically green odor suggesting fresh wet foliage, useful in woody, mossy, and certain floral types, and is probably the most frequently used acetal in perfumery. 5. Ethyl methyl phenyl glycidate is the chief component of artificial strawberry compounds. 6. Acetates are most profusely used of all the esters; the most important class of synthetic odorants produced is the aliphatic aldehydes.

Several types of dispensers suitable for fragrances have been known for many years. These include the familiar pump-type spray bottles and the gas-powered or “aerosol” cans. Both of these applicators dispense a stream or mist of liquid droplets on demand. A pump-type dispenser may be refillable or the pump head may be interchangeable among different reservoir bottles. Aerosol cans are most often disposable once the contents are exhausted. Other devices include a container with a porous wick that generally resembles a felt-tip pen and may be uncapped and dabbed on the user's skin at desired intervals. Yet another approach for controlled release of a fragrance or insect repellent involves an adhesive patch to be worn by the user, the patch having a multilayer structure intended to release a scent at a controlled rate (see Fischel-Ghodsian, U.S. Pat. No. 5,071,704).

An article of jewelry containing a refillable fragrance dispenser is disclosed by Chin, et al. in U.S. Pat. No. 4,785,642. The dispenser consists of a capped, cylindrical vial filled with an absorbent material and having a small hole in the cap, through which the fragrance escapes by natural evaporation.

Stationary devices that dispense fragrance into the air are broadly referred to as “room fresheners”. These may be substantially passive devices in which the desired fragrance is released by evaporation from a porous wick (see Compton et al., U.S. Pat. No. 4,323,193) or from a hydrogel (see Lanzet, U.S. Pat. No. 2,927,055; Graiver et al., U.S. Pat. No. 4,891,389). The evaporation rate may be controlled by manually opening or closing the device, by raising the wick, and so on. These devices may alternatively contain fans, heating elements, etc. to enhance or control the release of the selected fragrance.

A further class of fragrance dispensing devices includes systems for releasing fragrances, detergents, etc. into a lavatory. Various means have been described for controlling the release of these generally liquid substances to minimize waste. Such means include installing infrared detectors to actuate the device each time a user approaches or leaves (see, for example, Shieh, U.S. Pat. No. 5,377,363), electrical switches or hydraulic valves to actuate the device when the lavatory is flushed, and other means (see, for example, Stone, U.S. Pat. No. 6,694,534).

### OBJECTS AND ADVANTAGES

Objects of the present invention include the following: providing an apparatus and method for releasing small, controlled amounts of volatile compounds; providing a wearable fragrance dispenser that releases one or more selected fragrances in the vicinity of the wearer at selected rates or selected intervals; providing a wearable fragrance dispenser that also serves the aesthetic function of jewelry; providing a fragrance dispenser that may be concealed on the person; providing a means for dispensing selected fragrance compounds near the user without depositing the fragrance directly on the skin or clothing; and, providing a means of dispensing controlled doses of aromatherapy agents. These and other objects and advantages of the invention will become apparent from consideration of the following specification, read in conjunction with the drawings.

### SUMMARY OF THE INVENTION

According to one aspect of the invention, an apparatus for dispensing fragrances comprises: a fluid reservoir containing a selected fragrance; a solid-state microfluidic circuit to control the release of the fragrance from the reservoir; a solid state switching device configured to actuate the microfluidic circuit according to a selected program; and, a power supply configured to provide electric power to operate the switching device and the microfluidic circuit.

According to another aspect of the invention, a method of dispensing fragrances comprises the steps of: providing a fluid reservoir containing a selected fragrance; providing a solid-state microfluidic circuit configured to dispense the fragrance from said reservoir at a selected rate; providing a solid-state switching device configured to actuate the microfluidic circuit for a selected duration at selected times; and, providing a power supply sufficient to operate the switching device and the microfluidic circuit, whereby the fragrance may be withdrawn from the reservoir for vaporization into the surrounding air at a selected rate.

According to another aspect of the invention, a method of dispensing fragrances comprises the steps of: providing a fluid reservoir containing a selected fragrance, the fragrance having aromatherapeutic attributes; providing a solid-state microfluidic circuit configured to dispense the fragrance from the reservoir at a selected rate; providing a solid-state switching device configured to actuate the microfluidic circuit for a selected duration at selected times; and, providing a power supply sufficient to operate the switching device and the microfluidic circuit, whereby the fragrance may be withdrawn from the reservoir at a selected rate for vaporization into the surrounding air.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram of one embodiment of the present invention, in which a solid-state microfluidic device dispenses a fragrance from a fluid reservoir.

FIG. 2 is a schematic diagram of an embodiment of the invention in which the components of a fragrance-dispensing device are contained within a protective housing.

FIG. 3 is a schematic diagram of an embodiment of the invention having a plurality of fluid reservoirs, each containing a separate fragrance.

FIG. 4 is a schematic diagram of an embodiment of the invention adapted to be worn as a pendant.

### DETAILED DESCRIPTION OF THE INVENTION

In its most general form, the invention contains a fluid reservoir holding a desired fragrance in liquid form. The liquid may include such ingredients as essential oils, natural or synthetic odor compounds, esters, phenols, etc., along with solvents or diluents such as water, alcohol, etc. The fluid reservoir is connected to a microfluidic control element including one or more micromachined channels through which the fluid may be pumped in order to release the scent. A conventional solid-state controller is provided to actuate the microfluidic control element at selected intervals in order to maintain the desired level of fragrance release. A battery or other conventional power source (such as a photovoltaic cell) is provided to drive the various elements.

The foregoing components are preferably combined into a low-cost, substantially self-contained device or cartridge that may be disposable when the liquid is exhausted. A decorative housing unit may be provided to carry the cartridge, thereby doubling as an item of jewelry such as a necklace, brooch, hair clip, or the like. In this embodiment, the battery and/or solid-state controller may be contained in the housing unit, thereby minimizing the cost of the disposable cartridge element, and in that case the housing unit will contain electrodes that engage corresponding contacts on the cartridge. Various conventional means such as keyways, etc., may be used to ensure that the electrodes and contacts maintain the necessary alignment to engage properly.

Some exemplary categories of fluid dispensing technology include: Pin transfer, needle dispensing, jetting, and spraying. Pin transfer uses a pin that is dipped into a reservoir of fluid. The fluid is transferred to the part by touching the pin to surface of the part. Needle dispensing is one of the more common methods used in automated fluid dispensing. Material is extruded through a needle that is held close to the surface of a part. As the needle is pulled away, the fluid is held to the board by gravity and surface tension. A variety of devices can be used to extrude the material through the needle: auger pumps, pneumatic pumps, or piston pumps.

Needle dispensing devices may include valves to control the flow of very low viscosity fluids. Material viscosity from 1 cp (e.g., water) to over 1,000,000 cp (e.g., thick grease) can be dispensed with needles.

Jet dispensing energizes a specific quantity of fluid such that the kinetic energy of the fluid is used to break the fluid stream from the nozzle. Viscosities of 1 cp (e.g., water) to over 100,000 cp (e.g., surface mount adhesives) can be jetted with various mechanisms. Complex fluid rheology is an important factor in the suitability of a fluid for jetting. Picoliter volumes of low viscosity materials are widely used in printing technology; however, fluids used in these applications are generally limited to specially formulated inks. Jetting of materials likely to be used for MEMs assemblies, such as adhesives, find a practical limitation of approximately 3 nanoliters and larger. Diameters of approximately 250 μm are possible. Many of the limitations of solid content and filler size of needle dispensing apply to jetting.

Jetting fluids can provide some unique advantages. The energy for breaking the fluid from the nozzle comes from the kinetic energy of the fluid. Jetting is less sensitive to the gap between the nozzle and the part. The fluid stream from a jet can be as small as 100 μm in diameter, allowing fluid to be deposited in areas that it is not possible to place a needle.

Dot Dispensing: Large deposits of fluid can be made with relative ease, so the discussion here will focus on the practical lower limits available commercially. With pin transfer, fluid deposits of <1 nanoliter and 100 μm in diameter are possible with many adhesives. The stability of the processes are difficult to control since the amount of fluid deposited can vary as fluid characteristics change. The process requires open containers of fluid.

### Example

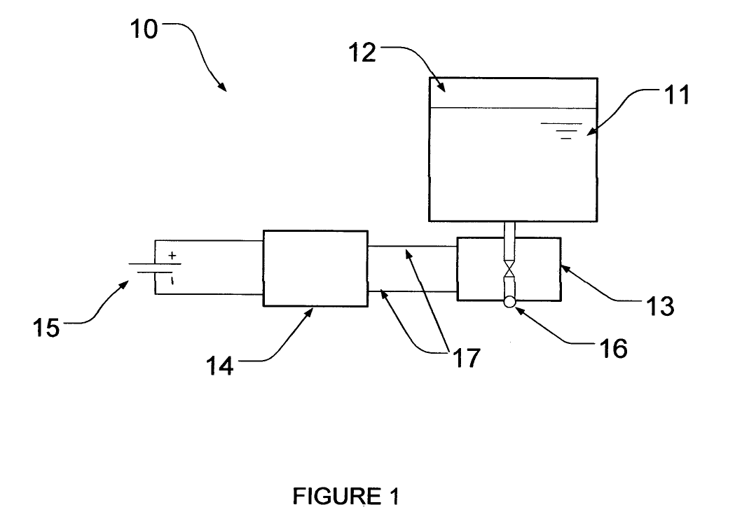

The basic elements of the invention are shown schematically at 10 in FIG. 1. Fragrant liquid 11 is contained within reservoir 12. A microfluidic device 13 receives liquid 11 from reservoir 12. A control circuit 14 receives power from power source 15, which may be a battery, photocell, or other suitable device, and applies an actuating signal to microfluidic device 13 through conductors 17. The actuating signal causes microfluidic device 13 to dispense a small droplet 16 of the fragrant liquid.

As shown in FIG. 1, it is preferable that the droplet 16 is dispensed to the surface of the device for evaporation, rather than forcefully ejected as would be the case in a typical ink-jet printer head. An ink-jet printer head may consume as much as 12 W of power. Simple dispensing, rather than forceful ejection, requires significantly less energy and is therefore more suited to a small, battery-powered device.

Skilled artisans may construct the inventive device by routine engineering practices using a number of suitable components, including the following: Suzuki et al. (Sensors and Actuators B 2002, 86, pp. 242-250) have described a micropump system, which could pump liquid at a rate of 2 nl per second with a 1.2 V bias and 0.1 mA current or 0.12 mW. A small fluidic reservoir could easily be attached to the micropump using conventional adhesives. Tsai et al. (J. of Microelectromechanical Systems 2002, 11[6], pp. 665-671) have described a thermal-bubble micronozzle-diffuser pump which is able to pump a very large volume of liquid at a rate of 4˜5 μl/min when the driving pulse is 250˜400 Hz and duty cycle of 5˜10% with a power consumption of about 0.5 W. When the system operates at 3 Hz pulse excitation frequency and the duty cycle of 5%, the average power consumption is only 50 mW. Commercially available “coin” lithium batteries (e.g., BRxxxx and CRxxxx series, Panasonic Corp.) have a power capacity up to 1000 mAh with a weight of a few grams that could provide enough power to operate the micropump continuously for more than one and half years.

From the foregoing description it will be apparent that the invention overcomes a fundamental limitation of prior fragrance dispensing approaches, viz., that a particular fragrance might include several components with differing rates of evaporation. A dispenser that relies on evaporation from a small orifice (as disclosed in U.S. Pat. No. 4,785,642) or one that relies on evaporation from a gel body (as described in U.S. Pat. No. 2,927,055) will invariably display some effect of differential evaporation. The composition of the fragrant material remaining in the reservoir will therefore tend to change somewhat with time and the perceived fragrance will change with it. In the inventive device, a very small volume of liquid is withdrawn from the reservoir and completely converted to vapor before a second volume of fluid is withdrawn. Thus, the bulk composition of the liquid remaining in the reservoir does not change with time and the fragrance is therefore more uniform.

Various approaches exist for manufacturing microfluidic devices that may be used to carry out Applicant's invention. Channels of the appropriate size may be etched into glass or silicon and various strategies may be used to pump the fluid, including local heating, electroosmotic effects, piezoelectric actuation, etc. Familiar examples of practical applications of microfluidic devices include ink-jet printers and various small-scale chemical reaction devices (see, for example, Ramsey, U.S. Pat. No. 5,858,195). A general summary of microfluidic technology and devices is given by Hansen, et al. (Current Opinion in Structural Biology 2003, 13, pp. 538-544), and Barry, et al. (Journal of Nanobiotechnology 2004, 2, pp. 2-6), and Erickson et al. (Analytica Chimica Acta 2004, 507[1], pp. 11-26), and Ziaie et al. (Advanced Drug Delivery Reviews 2004, 56[2], pp. 145-172) and Malek et al. (Microelectronics Journal 2004, 35[2], pp. 131-143), and Beebe et al. (Annual Review of Biomedical Engineering 2002, 4, pp. 261-286) and Darhuber (Annual Review of Fluid Mechanics 2005, 37, pp. 425-455). A piston-type pump made by MEMS techniques is disclosed by Galambos, et al. in U.S. Pat. No. 6,886,916. A microfabricated electrokinetic pump is disclosed by Corbin, et al. in U.S. Pat. No. 6,881,039. A pump and passive check valve is disclosed by Dai, et al. in U.S. Pat. No. 6,874,999. A method of building peristaltic micropumps using polydimethylsiloxane multilayer soft lithography is described by Goulpeau, et al. (Journal of Applied Physics 2005, 98, #044914). An electrokinetic pump for pumping a liquid including a pumping body having a plurality of narrow, short and straight pore apertures for channeling the liquid through the body is described by Corbin, et al. in U.S. Pat. No. 6,881,039; and by Kopf-Sill, et al. in U.S. Pat. Nos. 6,524,790; 6,613,512; and 6,703,205. A method of building a dielectric pump to move fluids which have two dissimilar dielectric constants from an interface through microchannels is described by Vacca in U.S. Pat. No. 6,949,176. An apparatus and method for controlling the delivery of fluids and, in particular, to the delivery of fluids to a receptor is described by Kane, et al. in U.S. Pat. No. 6,109,717. Shawgo, et al. (Current Opinion in Solid State & Materials Science 2002, 6[4], pp. 329-334) described MEMS-based micropumps and their applications for drug delivery. Any or all of the foregoing microfluidic devices and methods may be suitable to use in implementing the present invention.

As noted, the device preferably operates in a mode that avoids the forceful ejection of droplets (in contrast to the operation of an ink-jet printer, for example). Various elements may therefore be provided to help convert the pumped fluid to vapor. For example, a porous layer 19 may be disposed on an outside surface of the device; the microfluidic element may pump the fluid to this porous layer, from which it will evaporate in a controlled manner. Alternatively, a heating element 18 may optionally be provided, preferably as an integral part of the microfluidic device.

As discussed in the foregoing example, it is necessary to provide a means for actuating the microfluidic device, preferably for a selected duration at some selected time interval. This is preferably done using a small integrated circuit that contains at least a timing function and a switching function, and, preferably, a memory function. Those skilled in the art will appreciate that many conventional circuits will be suitable for this device, which may be implemented as an application specific integrated circuit (ASIC) or as a field-programmable gate array (FPGA) or similar device and its associated software. The skilled artisan, by applying routine engineering principles, may therefore select the most appropriate control circuit 14 based on the choice of microfluidic device 13, cost and performance objectives, power consumption, and other considerations. For the control circuit 14, appropriate time and drive signal could be provided by a microcontroller such as MAXIM (Dallas Semiconductor, Dallas, Tex.) DS80xx, DS87xx or DS89xx series. Some of these chips have a built-in memory and can be programmed by users. Other examples of suitable microcontrollers are Texas Instruments MSPxx series and Motorola MC68xx series chips.

In order for the device to be small and simple to use, it is generally preferred that the device has a single operating mode, wherein once activated by the user the device simply releases fragrance at regular intervals over a predefined time scale. However, it will be appreciated that a more sophisticated device can be constructed, whose operating parameters may be user-programmed over some range. Such user programming may be as simple as a small multiposition switch (e.g., low-medium-high) that can select either greater or lesser duration of the individual actuations or shorter or longer times between actuations. In a more sophisticated design, a continuous user-programmable controller may be used. This controller may further contain visual indicators such as LED elements or an LCD display to indicate various operating states. Alternatively, the device may be adapted to interact with a base station (through a temporary electrical connection, wireless data link, or the like) from which it may download a more complicated operating profile.

In many instances it will be preferable to provide a means such as a vent or check valve in order to allow air to enter the reservoir 12 to compensate for the volume of fragrant liquid 11 being removed therefrom. A mechanical check valve and air passage may be fabricated as one component on the microfluidic device 13 or other conventional venting means may be employed. It will be appreciated that in some instances it may be practical to pressurize the reservoir 12 in which case the microfluidic device 13 may be simplified to employ a valve rather than an active pumping mechanism.

### Example

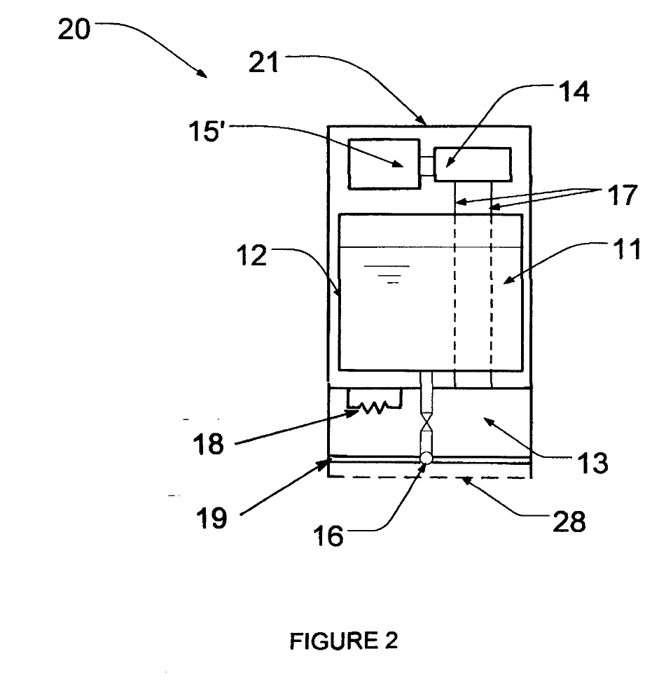

The components indicated schematically in FIG. 1 may be combined within a housing in order to provide a small, self-contained, and relatively robust unit as shown schematically in FIG. 2. An outer housing 21 is provided, which contains spring mounted battery 15′, control circuit 14, reservoir 12, and fragrance 11. The solid-state fluidic device 13 is located under reservoir 12 and is protected by a mesh 28, which serves to protect the surface of the device from damage while allowing the vaporized fragrance to escape. The mesh may further provide a decorative function if desired.

### Example

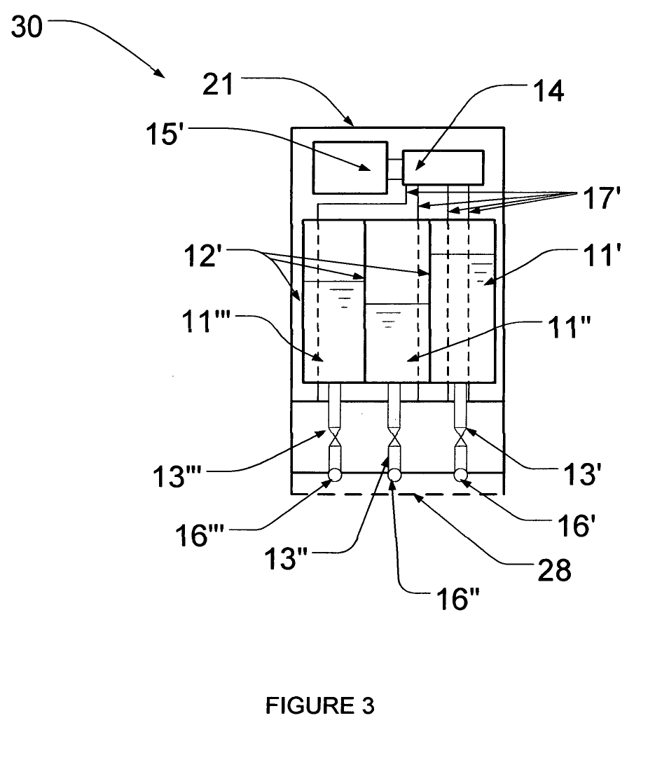

The invention may also be adapted to dispense more than one fragrance as shown generally at 30 in FIG. 3. Three separate reservoirs 12′ contain fluids 11′, 11″, and 11″′. As shown in FIG. 3, the device may be configured so that one multichannel solid state microfluidic device 13′ (driven by control circuit 14) receives fluids from each of the reservoirs 12′. It will be appreciated that the microfluidic device 13′ may be controlled to dispense individual fragrances 11′, 11″, and 11″′ selectively at various times, to dispense them as separate droplets at the same time, or to blend them in selected ratios and dispense droplets of the resulting blended composition. The components may be contained within housing 21 and protective mesh 28, as in the previous example.

It will be apparent to those skilled in the art that this embodiment may be implemented in many alternative configurations to achieve substantially the same purpose. For example, one housing unit may be configured to accept several dispensing cartridges 20, each with its own microfluidic device 13. The cartridges may be substantially self-contained, i.e., have individual power supply 15 and control circuit 14. Alternatively, the housing unit may contain a single power supply 15 with electrical contacts to engage each of the dispensing cartridges 20. The housing unit may further contain a single microprocessor or switching device 14 with electrical contacts to engage each of the microfluidic devices 13.

It will be further appreciated that although some exemplary devices are shown with an on-board battery as a preferred power source, any suitable power source may be used, including photovoltaic cells, capacitive storage elements, and others. The device may also be provided with a wire, cable, plug, or jack arrangement in order to accept power from a larger external power source. This may be useful, for example, in a device intended for use in an automobile, wherein power may be supplied via a wire in the auto's electrical system. Furthermore, the actuating signal from control circuit 14 may be delivered to microfluidic device 13 via a hard-wired connection or via a wireless link using any conventional wireless protocol.

It will be understood that in some instances the housing unit is intended to be a permanent piece of fine or costume jewelry, in which the wearer may replace the fragrance-dispensing unit when it is used up, or to select a different fragrance. In some cases, the housing unit may be worn for its decorative value even when fragrance is not being dispensed. Furthermore, it will be appreciated that the housing unit may provide a degree of mechanical protection to the cartridge, particularly in the case where the fluid reservoir is a small glass vial.

### Example

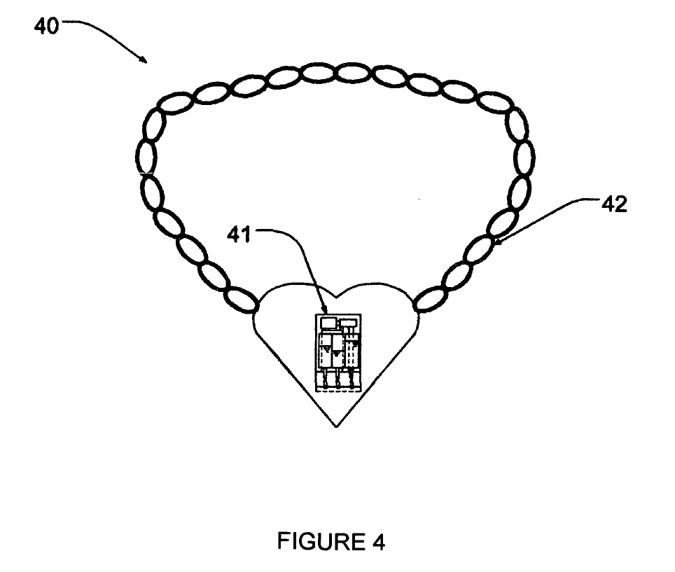

Illustrated schematically at 40 in FIG. 4 is an embodiment of the invention in which fragrance dispenser 41 is adapted with a chain 42, allowing it to be worn as a necklace. Similarly, dispenser 41 may be adapted to be attached to, or integral with, other personal items such as a pin, brooch, hair clip, wristwatch, telephone handset, and so on.

In other instances, it may be desirable to make the housing unit from very inexpensive materials so that the entire item is disposable once the fragrance has been completely dispensed. The housing unit may be provided with various conventional means for attachment to the body or clothing of the user; these means can include chains, hooks, pins, clips, and the like.

It will be further appreciated that in some applications the entire unit may be designed to be fairly unobtrusive during use. This might be advantageous, for example, in applications where the device is dispensing pheromones, masking agents, insect repellents, and the like. The unit may also be configured to fit in a user's shirt pocket, to accommodate a larger fluid reservoir, larger battery, etc., as might be desired for steady, long-term use by outdoorsmen or the military.

In the aforedescribed situations the device is configured so that it can be worn on the person. However, it will be appreciated that because the device is generally compact and self-contained, it may easily be deployed in other uses and locations. For example, it may be placed in the ventilation system of an automobile, the air outlet of an air conditioner, or other convenient location where the user desires to have a controlled release of fragrance at selected time intervals.

As noted earlier, perfumes, colognes, and other fragrant products are typically mixtures or solutions of numerous chemical compounds along with solvents and other additives. It will be understood that the inventive device may be used for dispensing any and all such mixtures, blends, solutions, or dispersions as are familiar to those skilled in the art of fragrance production and use. In the embodiment described in the foregoing examples, it will be understood that when the apparatus includes several fluid reservoirs, each of the individual fluids will, in turn, frequently be a mixture or solution in its own right but it may, in some cases, be a substantially pure component or concentrate.

The term aromatherapy describes a branch of holistic or “traditional” medicine wherein various healing attributes are associated with particular aromas. The practice of treating physical or mental problems by the inhalation of specific aromas has been carried out since ancient times and anecdotal evidence among practitioners in the art identifies dozens of fragrances purported to have some value in aromatherapy [see, for example V. A. Worwood, The Complete Book of Essential Oils and Aromatherapy, New World Library, 1991]. The materials typically used include essential oils or extracts of various plants, flowers, herbs, etc.

### Example

The inventive device may be used to dispense fragrances for aromatherapy treatment. Individual fragrances or combinations of fragrances may be selected by the user or prescribed by an aromatherapy practitioner, who may also recommend frequency or duration of treatment, etc. In this application, the inventive device offers the advantage that the aromatherapeutic agent is dispensed efficiently directly in the vicinity of the user, rather than dispersed into the air to fill a room, for example.

Some examples of materials that have been offered for aromatherapy include the following: angelica root, anise, Peru balsam, basil, bay, bay laurel, beeswax, bergamot, mint bergamot, bois-de-rose, boronia, cajeput, cardamom, carrot seed, cedarwood, chamomile, cinnamon, citronella, clary sage, clove bud, coriander, cypress, dill, elemi, eucalyptus, fennel, fir needle, frankincense, galbanum, geranium, rose geranium, ginger, grapefruit, helichrysum, hyssop, immortelle, jasmine, juniper berry, kanuka, lavender, lavendin, lemon, lemon grass, lime, linden blossom, mandarin, manuka, marjoram, may chang, myrrh, myrtle, neroli, niaouli, nutmeg, oakmoss, olibanum, bitter orange, sweet orange, oregano, palmarosa, parsley, patchouli, black pepper, peppermint, pettigrain, Scotch pine, ravensera, rose, rosemary, rosewood, sandalwood, spearmint, spikenard, spruce, tagetes, tangerine, tea tree, thyme, tobacco, tuberose, vanilla, vetiver, violet leaf, yarrow, and ylang-ylang. Many literature sources advise caution in using these materials because many essential oils, in concentrated form, can be toxic, irritating to the skin and mucous membranes, or allergenic. The present invention affords a particular advantage in the administration of such aromas because the method of dispensing the material effectively precludes direct contact of the fluid with the user's skin, eyes, or mucous membranes.

Aromatherapy products also frequently make use of solvents, such as water or alcohol, as well as “carrier oils” such as sweet almond, apricot kernel, avocado, borage, cocoa butter, evening primrose, grapeseed, hazelnut, jojoba, kukui, macadamia nut, olive, peanut, pecan, rose hip, sesame, shea butter, and sunflower.

Having described the invention in detail, I claim:

1. A method of dispensing fragrances comprising the steps of:
providing a fluid reservoir containing a selected fragrance;
providing a solid-state microfluidic circuit configured to dispense said fragrance from said reservoir at a selected rate;
providing a solid-state switching device configured to actuate said microfluidic circuit for a selected duration at selected times;
providing a power supply sufficient to operate said switching device and said microfluidic circuit;
actuating said microfluidic device to dispense a single droplet of said fragrance onto an external surface of said microfluidic device; and,
allowing said droplet to vaporize into the surrounding air before dispensing a subsequent droplet onto said surface.

2. The method of claim 1 wherein said solid state switching device comprises a device selected from the group consisting of: application specific integrated circuits and field-programmable gate arrays.

3. The method of claim 1 wherein said microfluidic circuit comprises a device selected from the group consisting of: piston pumps, electrokinetic pumps, peristaltic pumps, dielectric pumps, valves, check valves, nozzles, heaters, and micromachined fluid channels.

4. The method of claim 1 wherein said power supply comprises a device selected from the group consisting of: batteries and photovoltaic devices.

5. The method of claim 1 wherein said fragrance comprises a substance selected from the group consisting of: essential oils, natural plant extracts, natural animal extracts, synthetic esters, pheromones, and insect repellents.

6. The method of claim 1 wherein said fluid reservoir containing said fragrance is pressurized to an internal pressure greater than atmospheric and said microfluidic device contains a valve for controllably releasing said pressurized fluid.

7. A method of dispensing fragrances comprising the steps of:
providing a fluid reservoir containing a selected fragrance, said fragrance having aromatherapeutic attributes;
providing a solid-state microfluidic circuit configured to dispense said fragrance from said reservoir at a selected rate;
providing a solid-state switching device configured to actuate said microfluidic circuit for a selected duration at selected times; and,
providing a power supply sufficient to operate said switching device and said microfluidic circuit;
actuating said microfluidic device to dispense a single droplet of said fragrance onto an external surface of said microfluidic device; and,
allowing said droplet to vaporize into the surrounding air before dispensing a subsequent droplet.

8. The method of claim 7 wherein said aromatherapeutic fragrance comprises an essential oil selected from the group consisting of: angelica root, anise, Peru balsam, basil, bay, bay laurel, beeswax, bergamot, mint bergamot, bois-de-rose, boronia, cajeput, cardamom, carrot seed, cedarwood, chamomile, cinnamon, citronella, clary sage, clove bud, coriander, cypress, dill, elemi, eucalyptus, fennel, fir needle, frankincense, galbanum, geranium, rose geranium, ginger, grapefruit, helichrysum, hyssop, immortelle, jasmine, juniper berry, kanuka, lavender, lavendin, lemon, lemon grass, lime, linden blossom, mandarin, manuka, marjoram, may chang, myrrh, myrtle, neroli, niaouli, nutmeg, oakmoss, olibanum, bitter orange, sweet orange, oregano, palmarosa, parsley, patchouli, black pepper, peppermint, pettigrain, Scotch pine, ravensera, rose, rosemary, rosewood, sandalwood, spearmint, spikenard, spruce, tagetes, tangerine, tea tree, thyme, tobacco, tuberose, vanilla, vetiver, violet leaf, yarrow, and ylang-ylang.

9. The method of claim 7 wherein said aromatherapeutic fragrance further contains a carrier oil selected from the group consisting of: sweet almond, apricot kernel, avocado, borage, cocoa butter, evening primrose, grapeseed, hazelnut, jojoba, kukui, macadamia nut, olive, peanut, pecan, rose hip, sesame, shea butter, and sunflower.

10. The method of claim 7 wherein said aromatherapeutic fragrance further contains a solvent selected from the group consisting of: water, alcohols, and ketones.
